(19) United States
(12) Patent Application Publication
(10) Pub. No.: US 2026/0324582 A1
(43) Pub. Date: Oct. 22, 2026

(54) LITTER BOX, DETECTION SYSTEM AND CONTROL METHOD

(71) Applicant: Ying Chen, Ningbo (CN)

(72) Inventor: Ying Chen, Ningbo (CN)

(21) Appl. No.: 19/695,604

(22) Filed: Jun. 2, 2026

(51) Int. Cl. A01K 1/01

(52) U.S. Cl. CPC A01K 1/0114

(57) ABSTRACT

A litter box, a detection system, and a control method are provided. A touch sensor disposed at a position corresponding to a touch sensing area detects physical contact of a pet and outputs a trigger signal, and a controller controls a drive mechanism to stop operation according to the trigger signal, thereby improving reliability of detecting whether a pet is present and safety of the pet using the litter box.

### TECHNICAL FIELD

The present application relates to the field of smart home products, and in particular to a litter box, a detection system and a control method.

### BACKGROUND

Smart litter boxes are common devices for automatic pet cleaning, primarily used to achieve automatic separation and removal of pet excrement. Existing smart litter boxes are generally equipped with a rotatable litter compartment, a drive mechanism and a pet detection assembly. The drive mechanism drives the litter compartment to rotate, thereby automatically sifting litter from excrement, greatly reducing the burden of manual cleaning.

In the related art, most smart litter boxes rely on non-contact detection elements having a detection distance on the order of centimeters or more to determine whether a pet is present, so as to control start and stop of the litter compartment. However, such non-contact detection methods are susceptible to environmental influences.

### SUMMARY

In view of this, embodiments of the present invention provide a litter box, a detection system and a control method, which facilitate improving the reliability of detecting whether a pet is present in the litter box.

To achieve the above object, the present invention provides the following technical solutions:

In a first aspect, an embodiment of the present invention provides a litter box, comprising: a housing defining an interior chamber, the interior chamber having an opening; a litter compartment rotatably mounted in the interior chamber, an entrance of the litter compartment corresponding to the opening, the litter compartment being configured to be driven to rotate at least to separate feces from litter; at least a portion of the housing or the litter compartment is configured as a touch sensing area for a pet entering or leaving the litter compartment; a drive mechanism in driving connection with the litter compartment, for driving the litter compartment to rotate; at least one touch sensor disposed at a position corresponding to the touch sensing area, the touch sensor configured to detect physical contact by a pet and output a trigger signal; the physical contact comprising at least one of: direct contact between the pet and the touch sensing area, and a spacing between the pet and the touch sensing area on the order of millimeters or less; and a controller electrically connected to the drive mechanism and the touch sensor respectively, the controller being at least configured to: receive the trigger signal output by the touch sensor, and control the drive mechanism to stop operation according to the trigger signal.

According to an embodiment of the present invention, the touch sensor comprises a touch sensing electrode, the touch sensing electrode is disposed on an inner surface of the housing at a position corresponding to the touch sensing area, for sending, to the controller, a signal indicative of contact between the pet and the housing.

According to an embodiment of the present invention, the touch sensing area comprises at least one of: a surface of the opening, a surface of the entrance, an inner wall surface of the litter compartment, a side wall of the interior chamber of the housing, and a surface of a connection between the opening and the entrance.

According to an embodiment of the present invention, the touch sensing electrode is adhered to a surface of the housing by adhesive backing, or is snap-fitted and secured in a pre-formed groove on the inner wall of the housing.

According to an embodiment of the present invention, an outer surface of the touch sensor is covered with a waterproof and dustproof protective layer.

According to an embodiment of the present invention, the touch sensor comprises a plurality of touch sensing electrodes, and the plurality of touch sensing electrodes are symmetrically disposed on two opposite side walls of the opening, or the entrance, or the connection between the opening and the entrance.

According to an embodiment of the present invention, the touch sensor comprises a plurality of touch sensing electrodes, and the plurality of touch sensing electrodes are disposed on a bottom surface and two opposite side walls of the opening, or the entrance, or the connection between the opening and the entrance, thereby forming a closed detection area surrounding the opening, or the entrance, or the connection between the opening and the entrance.

According to an embodiment of the present invention, the touch sensor comprises a touch control chip and a touch sensing electrode, the touch control chip is disposed on the housing, and the touch sensing electrode is disposed on an inner wall surface of the litter compartment. In other embodiments, the touch control chip may also be directly soldered on the touch sensing electrode, or its function integrated in the controller.

According to an embodiment of the present invention, the litter box further comprises at least one non-contact sensor, the non-contact sensor being one or more of an infrared sensor, a laser sensor, a microwave sensor, a weighing sensor or a Hall sensor, the non-contact sensor being electrically connected to the controller and configured to detect a presence state of a pet.

According to an embodiment of the present invention, the controller is configured to: in a normal working mode, control the drive mechanism to operate based on a detection signal of the non-contact sensor; wherein, during a cleaning cycle, the controller is configured to continuously monitor the touch sensor and control the drive mechanism to stop operation upon receiving the trigger signal.

According to an embodiment of the present invention, the controller is further configured to: when the non-contact sensor detects that the pet has left the litter compartment and the touch sensor does not output the trigger signal within a preset safety confirmation delay, control the drive mechanism to start a cleaning cycle operation.

According to an embodiment of the present invention, the controller is further configured to: when a duration of the trigger signal of the touch sensor exceeds a preset abnormal alarm duration, control to issue an audible and visual alarm.

According to an embodiment of the present invention, the controller is further configured to: during the safety confirmation delay, if the touch sensor or the non-contact sensor detects the presence of a pet again, reset a delay timer; and, after the trigger signal of the touch sensor is released, resume the normal working mode.

According to an embodiment of the present invention, the non-contact sensor comprises an infrared sensor and a weighing sensor, the infrared sensor is disposed at a periphery of the entrance or at two ends of a rotation shaft of the litter compartment, a detection beam of the infrared sensor traversing the entrance or an interior space of the litter compartment; the weighing sensor is disposed at a bottom of the housing, for detecting a weight change of the litter compartment.

According to an embodiment of the present invention, the controller is further configured to: when the infrared sensor detects that a pet enters and the weighing sensor detects an increase in weight, confirm that the pet has entered the litter compartment and prohibit the drive mechanism from starting; when the infrared sensor detects that the pet leaves and the weighing sensor detects a decrease in weight, confirm that the pet has left the litter compartment and enter a state to start a cleaning cycle.

According to an embodiment of the present invention, a sifter is fixedly disposed inside the litter compartment, the sifter being used for separating the litter from the feces during rotation of the litter compartment.

According to an embodiment of the present invention, at least two rollers are disposed inside the housing, the litter compartment is supported on the rollers, and the rollers are in rolling contact with an outer surface of the litter compartment.

According to an embodiment of the present invention, the touch sensor is at least one selected from a capacitive touch sensor, a resistive touch sensor and a piezoelectric touch sensor.

Correspondingly, an embodiment of the present invention further provides a pet presence detection system for a litter box, comprising: at least one touch sensor configured to be disposed at a position corresponding to the touch sensing area, for detecting the presence of a pet through physical contact and outputting a trigger signal; the physical contact comprising at least one of: direct contact between the pet and the touch sensing area of the litter compartment, and a spacing between the pet and the touch sensing area on the order of millimeters or less; a controller electrically connected to the touch sensor, the controller configured to: receive the trigger signal output by the touch sensor, and control a drive mechanism of the litter box to stop operation according to the trigger signal.

An embodiment of the present invention further provides a control method for a litter box, comprising: detecting, by at least one touch sensor, whether physical contact occurs between a pet and a touch sensing area of the litter box, the touch sensing area being disposed corresponding to a position where the pet enters or leaves a litter compartment of the litter box, the physical contact comprising at least one of: direct contact between the pet and the touch sensing area of the litter compartment, and a spacing between the pet and the touch sensing area on the order of millimeters or less; when a physical contact signal is detected, controlling the litter compartment to stop rotating or prohibiting the litter compartment from starting.

### BRIEF DESCRIPTION OF THE DRAWINGS

In order to more clearly illustrate the embodiments of the present invention or the technical solutions in the prior art, the drawings required for the description of the embodiments or the prior art will be briefly introduced below. Obviously, the drawings in the following description are merely some embodiments of the present invention. For those of ordinary skill in the art, other drawings can be obtained based on these drawings without creative efforts.

FIG. 1 is an exploded schematic view of a litter box according to an embodiment of the present invention.

FIG. 2 is a front view of the litter box according to an embodiment of the present invention.

FIG. 3 is a cross-sectional view taken along line A-A of the litter box in FIG. 2.

FIG. 4 is an enlarged schematic view of the structure at B in FIG. 3.

FIG. 5 is a schematic structural view of the litter box of FIG. 1 with an outer shell removed, according to an embodiment.

FIG. 6 is an enlarged schematic view of the structure at C in FIG. 5.

FIG. 7 is a schematic structural view of the litter box of FIG. 5 from another perspective.

FIG. 8 is an exploded schematic structural view of another type of litter box provided by an embodiment of the present invention.

FIG. 9 is a schematic assembly structural view of the litter box of FIG. 8.

FIG. 10 is a flowchart of a control method for a litter box according to an embodiment of the present invention.

### DESCRIPTION OF EMBODIMENTS

The technical solutions in the embodiments of the present invention will be clearly and completely described below with reference to the drawings in the embodiments of the present invention. Obviously, the described embodiments are merely some, but not all, of the embodiments of the present invention. Based on the embodiments in the present invention, all other embodiments obtained by those of ordinary skill in the art without making creative efforts fall within the protection scope of the present invention.

Currently, smart litter boxes generally use non-contact sensors such as infrared, laser, weighing, etc. to detect whether a pet is present, so as to control the start and stop of the litter compartment. However, in actual use, such detection methods may encounter problems: the dusty environment inside the litter box tends to block the sensor light path, and dark pet hair and changes in ambient light can also lead to reduced detection reliability. Once the sensor fails to detect, the rotating litter compartment may pinch the pet, posing a certain safety hazard.

At least to solve the above technical problem, embodiments of the present invention provide a litter box with a contact-type safety detection function. By configuring one or more positions of the litter box that the pet may come into contact with as a touch sensing area, and disposing a touch sensor at a position corresponding to the touch sensing area, the physical contact of the pet is directly detected and the litter compartment is timely braked in response, thereby improving the reliability of the litter box in detecting whether a pet is present, and fundamentally enhancing the safety of the device in use.

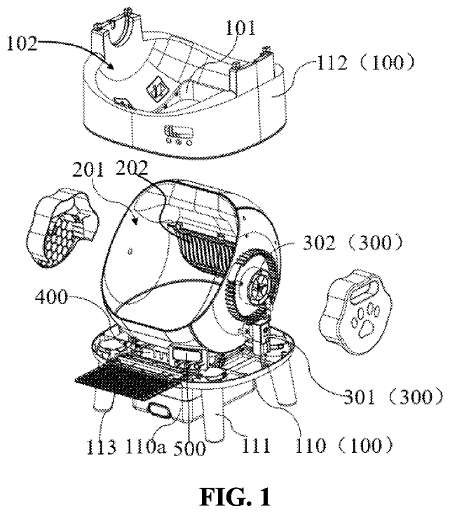

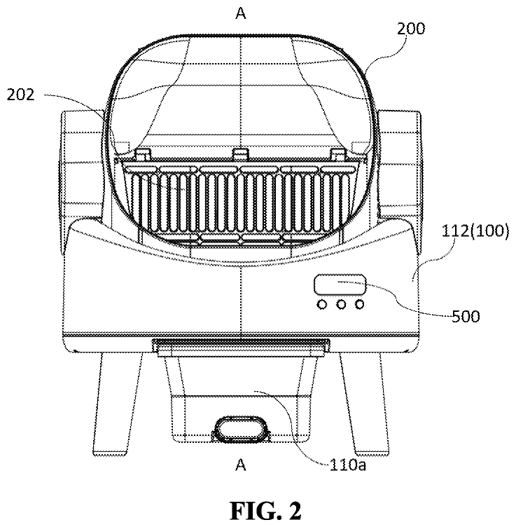

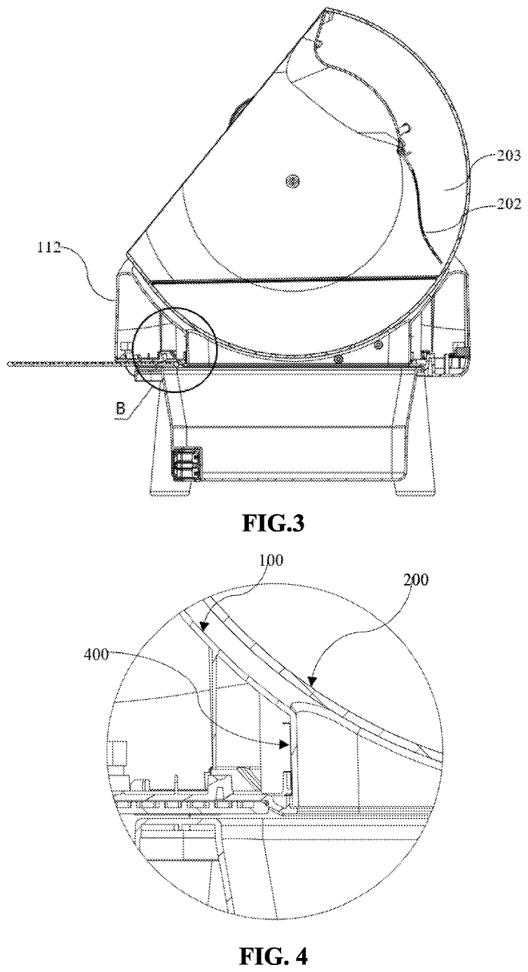

Referring to FIGS. 1 to 4, a litter box according to an embodiment of the present invention comprises: a housing 100, a litter compartment 200, a drive mechanism 300, at least one touch sensor 400 and a controller 500.

The housing 100 defines an interior chamber 101, and the interior chamber 101 has an opening 102 for the pet to enter and exit. In some embodiments, the housing 100 may be integrally formed by injection molding, for example using ABS (Acrylonitrile Butadiene Styrene) engineering plastic, PC (Polycarbonate) or ABS/PC alloy material, or may be assembled from multiple components.

In some embodiments, the housing 100 comprises: a base 110. The upper portion of the base 110 is a hollow disc-shaped structure, and the bottom is provided with four support feet 111, allowing the device to be stably placed on a flat surface. An operation panel is embedded on a peripheral side portion of the base 110 for manual operation by a user, and a status display screen can also be provided as needed. A pull-out storage box 110a is further provided on the side portion of the base for collecting the fecal waste separated from the litter compartment. This pull-out storage box can be inserted into the hollow space of the base, and when fecal waste falls into the storage box, it can be pulled outward for the user to conveniently clean.

On the base 110, above the hollow disc-shaped structure, an outer shell 112 is formed that surrounds the litter compartment, either by connection or by extending upward from the edge of the hollow disc-shaped structure. The outer shell 112 can be a cylindrical or hemispherical structure, forming the interior chamber 101 at its center. An opening 102 is provided on the outer shell for the pet to enter and exit the litter compartment. The outer shell is fixed, by snap-fit or screws, or integrally formed, on the upper hollow disc-shaped structure of the base.

A stepping platform 113 extends horizontally from the plane of the hollow disc-shaped structure of the base. The stepping platform 113 can be a detachable pedal, or can be formed by extending from the plane of the hollow disc-shaped structure. Specifically, the surface of the stepping platform 113 can be provided with an anti-slip raised texture or grid structure, which not only facilitates the pet stepping in and out, but also scrapes off litter from the pet's paws when the pet enters or exits.

The stepping platform 113 is disposed on an entry/exit path from a side of the base to the opening, forming part of the pet's entry/exit path. The stepping platform 113 may also serve as a location for arranging a touch sensing electrode. The outer shell 112 defines the interior chamber 101.

The litter compartment 200 is rotatably mounted in the interior chamber 101 of the housing 100, and is provided with an entrance 201 for the pet to enter and exit. The entrance 201 corresponds to the opening 102 on the housing 100, so that the pet can enter the interior of the litter compartment 200 through the opening of the housing to relieve itself.

The litter compartment 200 is configured to be driven to rotate at least to separate feces from litter. A sifter 202 is provided inside, and during the rotation of the litter compartment 200, the litter passes through the sifter 202 and falls back to a litter collecting area 203, while the feces are intercepted on the sifter 202.

At least a portion of the housing 100 or the litter compartment 200 is configured as a touch sensing area for a pet entering or leaving the litter compartment. As used herein, the “touch sensing area” refers to one or several discrete or continuous areas on the litter box configured to detect contact or a spacing on the order of millimeters or less by a pet's body. The touch sensing area can be configured according to the specific product and positions that the pet may come into contact with. Generally, the touch sensing area can include at least one of: a surface of the opening of the housing, a surface of the entrance of the litter compartment, an inner wall surface of the litter compartment, a side wall of the interior chamber of the housing, and a surface of the connection between the opening and the entrance. Any position on the litter box that the pet may come into contact with can be configured as the touch sensing area, and a touch sensor can be disposed at any position corresponding to the touch sensing area to trigger a sensing signal.

The drive mechanism 300 is in driving connection with the litter compartment 200, for providing power for the rotation of the litter compartment 200 and driving the litter compartment 200 to rotate. The drive mechanism 300 generally comprises a DC reduction motor 301 and a transmission gear set 302. The output shaft of the DC reduction motor 301 meshes with a rear end rotating shaft of the litter compartment 200 via the transmission gear set 302, thereby driving the litter compartment 200 to rotate.

The touch sensor 400 is disposed at a position corresponding to the touch sensing area, and is configured to detect physical contact by a pet and output a trigger signal. The physical contact comprises at least one of: direct contact between the pet and the touch sensing area of the litter compartment, and a spacing between the pet and the touch sensing area on the order of millimeters or less. In conventional detection solutions, a non-contact sensor 700 generally triggers a sensing signal by detecting a physical spacing on the order of centimeters or more. Unlike conventional non-contact sensors, in the present invention, the detection principle of the touch sensor 400 can be based on capacitance, resistance or voltage changes caused by a biological body's physical contact or approach at a spacing on the order of millimeters or less to the touch sensing area as the sensing signal, and is hardly interfered by factors such as ambient light, dust, and hair. Herein, the spacing on the order of millimeters or less refers to a spacing between the biological body and the touch sensing area having a length dimension on the order of millimeters or less.

In some embodiments, the touch sensor 400 can employ a capacitive touch sensor, and can also employ a resistive touch sensor or a piezoelectric touch sensor. When it is a capacitive touch sensor, the touch sensor can be disposed on a hidden internal surface of the housing; when it is a resistive touch sensor or a piezoelectric touch sensor, the touch sensor can also be disposed on an exposed surface of the housing.

The controller 500 is electrically connected to the drive mechanism 300 and the touch sensor 400 respectively. The controller 500 is at least configured to receive the trigger signal output by the touch sensor 400, and control the drive mechanism 300 to stop operation according to the trigger signal.

When a pet accidentally touches the touch sensing area during the rotation of the litter compartment 200, the touch sensor 400 at the corresponding position detects the contact and sends a trigger signal to the controller 500. After receiving the signal, the controller 500 immediately cuts off the power supply to the drive mechanism 300, stopping the rotation of the litter compartment 200 to prevent the pet from being pinched. In some embodiments, the controller 500 can also be connected to a wireless communication module to realize remote control and status monitoring functions, such as communicating with some terminal devices to control and monitor the status of the litter box on the terminal device.

In the litter box provided by this embodiment, by employing the contact-type touch sensor 400 as at least one method for detecting pet presence, by configuring on the litter box a touch sensing area for the pet entering or leaving the litter compartment, and disposing a touch sensor at a position corresponding to the touch sensing area, the touch sensor directly senses the physical contact of the pet and outputs a trigger signal, and the controller can timely control the drive mechanism to stop operation according to the trigger signal. Compared with conventional detection solutions relying on non-contact sensors having a detection distance on the order of centimeters or more, this can avoid, to a certain extent, detection failure problems easily caused by environmental influences such as light occlusion, thereby improving the reliability of the litter box in detecting whether a pet is present, and timely braking the rotation drive mechanism the moment the pet contacts the device, thus improving the safety of the pet using the litter box.

In some embodiments, the touch sensor comprises a touch sensing electrode 401. The touch sensing electrode 401 is disposed on an inner surface of the housing 100 at a position corresponding to the touch sensing area, for sending a contact signal indicative of contact between the pet and the housing to the controller 500.

Specifically, the positions where the surface of the opening 102 can be configured as the touch sensing area include the upper surface of the threshold of the opening 102, and the stepping platform 113 at the front end of the threshold. The positions where the surface of the litter compartment 200 can be configured as the touch sensing area can include the inner surfaces of the left and right side walls and the inner surface of the upper edge of the litter compartment.

In this embodiment, the touch sensor 400 can be disposed corresponding to the touch sensing area, and the sensors can be flexibly arranged according to different product structures and safety requirements, forming an omnidirectional detection area without dead angles. Thus, no matter from which direction the pet contacts the device, or at which stage of the entry/exit process it is, it can be accurately detected by the touch sensor 400, thereby enhancing the reliability and comprehensiveness of the safety detection.

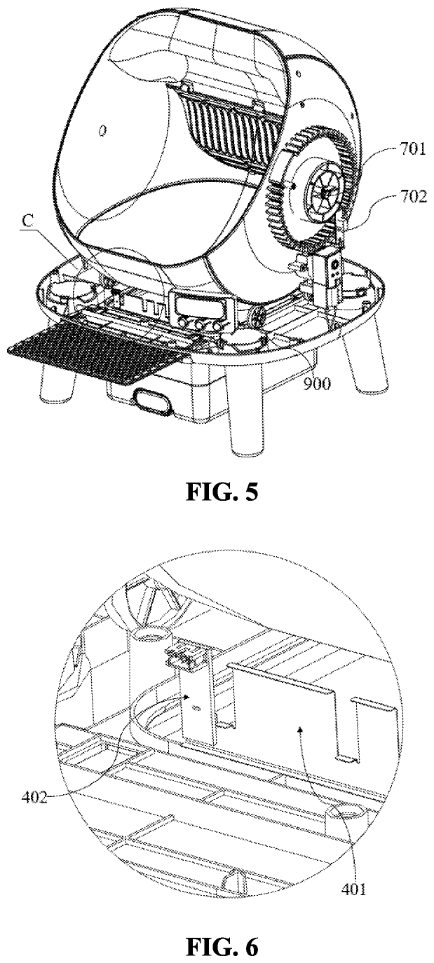

Referring to FIGS. 5 and 6, in some embodiments, the touch sensor 400 comprises a touch sensing electrode 401 and a touch control chip 402. The touch sensing electrode 401 is electrically connected to the touch control chip 402. The touch sensing electrode 401 is disposed on the surface at the opening 102 of the housing 100, or disposed on the side wall of the interior chamber 101 of the housing 100, for sending a physical contact signal between the pet and the housing 100 to the controller 500 via the touch control chip 402. Specifically, the touch sensing electrode 401 is generally made of a sheet-like conductive material, such as copper foil, aluminum foil, iron sheet or conductive plastic, having good flexibility and capable of closely fitting onto the inner surface of the housing 100. Referring to FIG. 8, the shape of the touch sensing electrode 401 can be customized according to the mounting position. For example, the touch sensing electrode 401 mounted on the upper surface of the threshold can be designed as a rectangular sheet structure; and the touch sensing electrode 401 mounted on the inner surface of the side wall can be designed as a rectangle, square or arc shape.

The touch control chip 402 may include an electrical signal detection circuit, a signal filtering circuit, a threshold comparison circuit and a digital output circuit, and can collect the capacitance change of the touch sensing electrode 401 in real time and perform filtering processing on the signal. When a pet contacts or approaches the outer surface of the housing 100, it causes the capacitance value of the touch sensing electrode 401 to change. When the change amount exceeds a preset detection threshold, the touch control chip 402 outputs a digital trigger signal to the controller 500, notifying the controller 500 to execute a braking operation. The detection threshold of the touch control chip 402 can be adjusted by software to adapt to different usage environments and detection requirements. To highlight the innovative aspects of the present invention, detailed description of conventional technologies such as the touch control chip and the controller is omitted.

In the present invention, the connection manner and integration degree between the touch control chip 402 and the touch sensing electrode 401 can be flexibly configured according to actual design requirements.

In this embodiment, the touch control chip 402 is directly soldered on the touch sensing electrode 401, forming an integrated touch detection module. This integrated module can be directly mounted as a whole assembly at a position of the litter box where touch needs to be detected (such as the inner wall surface of the litter compartment 200, the edge of the opening 102 of the housing 100, etc.), and has the advantages of a compact structure, short signal transmission path and strong anti-interference ability.

In some embodiments, the touch control chip 402 is separately disposed (for example, disposed on an independent circuit board), and is electrically connected to the touch sensing electrode 401 via a wire. This manner facilitates arranging the touch control chip 402 at a position with more ample space, and is suitable for scenarios where the mounting space of the touch sensing electrode 401 is limited or multiple touch sensing electrodes 401 need to share one touch control chip 402.

In some embodiments, the function of the touch control chip 402 can also be integrated into the controller 500, i.e., without providing an independent touch control chip 402, the controller 500 directly detects the capacitance, resistance or voltage change of the touch sensing electrode 401, and determines whether physical contact occurs based thereon. This manner can further reduce hardware costs and simplify circuit design.

In some embodiments, the touch sensing electrode 401 is adhered to the surface of the housing 100 by adhesive backing, or is snap-fitted and secured in a pre-formed groove on the inner wall of the housing 100.

Specifically, when the adhesive backing manner is adopted, a double-sided conductive adhesive can be pre-coated on the back surface of the touch sensing electrode 401, so that it has good electrical conductivity and adhesive strength. During installation, it is only necessary to align the touch sensing electrode 401 with the preset position on the inner surface of the housing 100, and press firmly to complete the fixation, making the operation simple and convenient.

In some embodiments, the outer surface of the touch sensor 400 is covered with a waterproof and dustproof protective layer 403. The waterproof and dustproof protective layer 403 is usually made of epoxy resin, silicone or polyimide material, covering the surfaces of the touch sensing electrode 401 and the touch control chip 402. The protective layer can be formed by potting or spraying, and can tightly wrap all electronic components of the sensor, preventing litter dust, urine, water vapor, etc. from entering the sensor interior and causing short circuits or damage.

By providing the waterproof and dustproof protective layer 403 on the outer surface of the touch sensor 400, this embodiment enables the sensor to adapt to the high-humidity and high-dust environment inside the litter box, thereby extending the service life of the sensor and ensuring the long-term reliability of the detection performance.

In some embodiments, the touch sensor 400 comprises a plurality of touch sensing electrodes 401, and the plurality of touch sensing electrodes 401 are symmetrically disposed on two opposite side walls of the opening 102, or the entrance 201, or the connection between the opening 102 and the entrance 201. Specifically, one touch sensing electrode 401 is respectively disposed on the inner surface of the left side wall and the inner surface of the right side wall of the opening 102, with the two electrodes distributed symmetrically left and right. The detection area of each touch sensing electrode 401 extends toward the center of the opening 102, and the detection areas of the two electrodes can overlap each other at the center of the opening 102, forming a continuous detection zone. This symmetrical arrangement can ensure that when a pet enters the opening 102 from the left side or the right side, it can be uniformly and accurately detected.

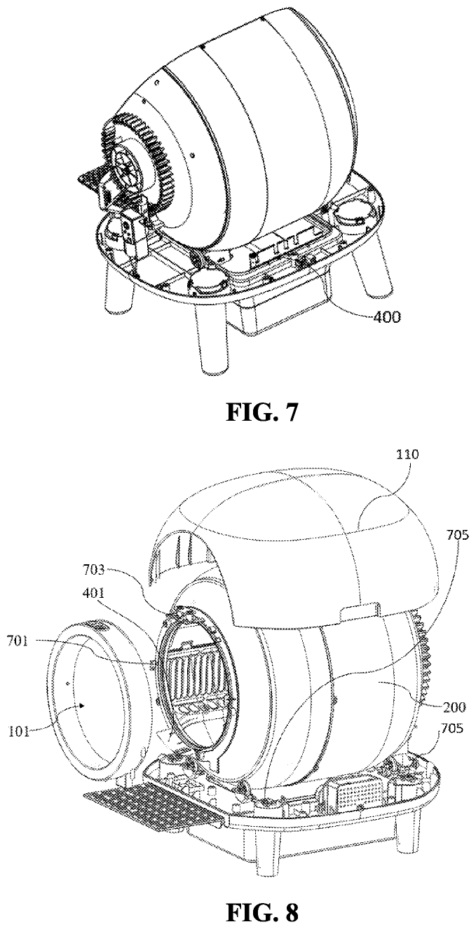

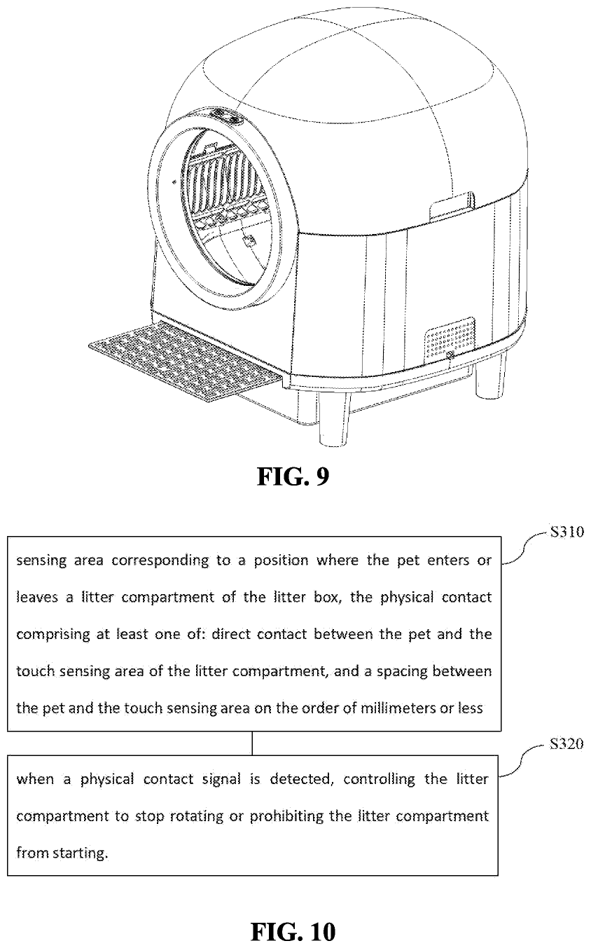

Referring to FIG. 7, specifically, the touch sensor 400 can also be disposed at the rear half of the base 110 of the housing 100, below the litter compartment.

In some embodiments, the touch sensing electrodes 401 can also be symmetrically disposed on the two opposite side walls of the entrance 201, or symmetrically disposed on the two opposite side walls of the connection between the opening 102 and the entrance 201.

In this embodiment, by symmetrically disposing the plurality of touch sensing electrodes 401, a uniform and continuous detection area can be formed, effectively improving the accuracy and reliability of the detection.

In some embodiments, the touch sensor 400 comprises a plurality of touch sensing electrodes 401, and the plurality of touch sensing electrodes 401 are disposed on the bottom surface and the two opposite side walls of the opening 102, or the entrance 201, or the connection between the opening 102 and the entrance 201, thereby forming a closed detection area surrounding the opening 102, or the entrance 201, or the connection between the opening 102 and the entrance 201.

FIG. 8 is an exploded schematic view of another type of litter box provided by an embodiment of the present invention. Referring to FIG. 8, for example, the touch sensing electrode 401 is disposed on the bottom surface of the connection between the opening 102 and the entrance 201.

Specifically, a long strip-shaped touch sensing electrode 401 is disposed on the upper surface of the threshold of the opening 102, and one sheet-like touch sensing electrode 401 is disposed on the inner surface of the left side wall and the inner surface of the right side wall of the opening 102 respectively. The three electrodes are connected end to end, forming a U-shaped closed detection area that completely surrounds the lower half of the opening 102. When any part of the pet contacts the threshold or the two side walls, the corresponding touch sensing electrode 401 will be triggered. In some embodiments, a touch sensing electrode 401 can also be additionally disposed on the inner surface 102c of the upper edge of the opening 102, forming a complete annular closed detection area covering all edges of the opening 102. By disposing the plurality of touch sensing electrodes 401 at the bottom and the two side walls of the opening, this embodiment forms an omnidirectional closed detection area, which can maximize the comprehensiveness of the safety detection.

In some embodiments, the touch sensor 400 comprises a touch control chip 402 and a touch sensing electrode 401. The touch control chip 402 is disposed on the housing 100, and the touch sensing electrode 401 is disposed on the inner wall surface of the litter compartment 200. The touch sensing electrode 401 is electrically connected to the touch control chip 402.

In this embodiment, even if the pet has completely entered the interior of the litter compartment 200, as long as it touches the touch sensing electrode 401 on the inner wall, braking can be triggered, thereby improving the safety of the device.

Referring again to FIG. 5, in some embodiments, the litter box further comprises at least one non-contact sensor. The non-contact sensor is one or more of an infrared sensor 701, a laser sensor, a microwave sensor, a weighing sensor 705 or a Hall sensor 702. The non-contact sensor is electrically connected to the controller 500 and configured to detect the presence state of a pet.

In this embodiment, by providing multiple optional non-contact detection solutions, flexible selection can be made according to different product positioning and cost requirements, and simultaneously, the combination of multiple sensors is supported, further improving the reliability of the main detection system.

In some embodiments, the controller 500 is configured to: in a normal working mode, control the drive mechanism 300 to operate based on the detection signal of the non-contact sensor; wherein, during a cleaning cycle, the controller 500 is configured to continuously monitor the touch sensor and control the drive mechanism 300 to stop operation upon receiving the trigger signal. In the normal working mode, the controller 500 continuously receives detection data from the non-contact sensor. When the non-contact sensor detects that a pet has entered the litter compartment 200, the controller 500 locks the drive mechanism 300 and prohibits it from starting any rotation action; when the non-contact sensor detects that the pet has left, the controller 500 enters a standby cleaning state. During the entire cleaning cycle, the controller 500 simultaneously monitors the signal state of the touch sensor 400. Once it receives the trigger signal output by any touch sensing electrode 401, it cuts off the power supply of the drive mechanism 300, causing the litter compartment 200 to stop rotating immediately. In this embodiment, through a dual detection mechanism of the non-contact and contact sensors, the safety of the pet during the use of the litter box can be improved.

In some embodiments, the controller 500 is further configured to: when the non-contact sensor detects that the pet has left the litter compartment 200 and the touch sensor 400 does not output the trigger signal within a preset safety confirmation delay, control the drive mechanism 300 to start a cleaning cycle operation. The duration of the safety confirmation delay can be adjusted through the program of the controller 500. By setting this delay, the potential safety problem that the pet might temporarily leave the litter compartment 200 and immediately return can be avoided.

During the safety confirmation delay, the controller 500 can simultaneously continuously monitor the signals of the non-contact sensor and the touch sensor 400. As long as any one of the sensors detects the presence of the pet, the delay timer is reset, and the cleaning cycle is formally started only after the pet has completely left and there is no contact signal throughout the entire delay period. After the cleaning cycle is started, the drive mechanism 300 drives the litter compartment 200 to rotate according to a preset rotation speed and angle, completing the separation and collection of the litter and feces.

In some embodiments, the controller 500 is further configured to: when the duration of the trigger signal of the touch sensor 400 exceeds a preset abnormal alarm duration, control to issue an audible and visual alarm.

When the touch sensor 400 continuously outputs the trigger signal for more than the abnormal alarm duration, it may indicate that an abnormal situation exists, such as a pet being trapped in the litter compartment 200, the sensor being stuck by a foreign object, or a device failure. At this time, the controller 500 drives an audible and visual alarm assembly to issue an alarm signal. The audible and visual alarm assembly can include a buzzer and an LED (Light Emitting Diode) indicator. The buzzer emits an intermittent prompt tone, and the LED indicator provides a warning in a red flashing manner. The alarm signal will continue to be issued until manually released by the user or the abnormal situation disappears, thereby enhancing the use safety and reliability of the device.

In some embodiments, the controller 500 is further configured to: during the safety confirmation delay, if the touch sensor or the non-contact sensor detects the presence of a pet again, reset the delay timer; and, after the trigger signal of the touch sensor 400 is released, resume the normal working mode.

When the fault causing the trigger signal is resolved, for example, the pet leaves the touch area, or the foreign object stuck to the sensor is removed, the touch sensor 400 stops outputting the trigger signal. As an optional embodiment, at this time, the controller 500 automatically performs a system self-check. After confirming that the drive mechanism 300, the non-contact sensor and the touch sensor 400 are all working normally, it automatically resumes the normal working mode without the need for manual reset operation by the user. If a device fault is found during the self-check, the controller 500 will maintain the alarm state and display a corresponding fault code through the operation panel, facilitating the user's troubleshooting and maintenance.

In some embodiments, the non-contact sensor 700 comprises an infrared sensor 701 and a weighing sensor 705. The infrared sensor 701 is disposed at the periphery of the entrance or at two ends of a rotation shaft of the litter compartment 200, and a detection beam of the infrared sensor 701 traverses the entrance or the interior space of the litter compartment. The weighing sensor 705 is disposed at the bottom of the housing, for detecting the weight change of the litter compartment.

Referring to FIG. 5, specifically, the infrared sensor 701 is disposed at the two ends of the rotation shaft of the litter compartment, and the detection beam of the infrared sensor 701 traverses the interior space of the litter compartment 200; the weighing sensor 705 can be disposed at the bottom of the housing 100, for detecting the weight change of the litter compartment 200.

Referring to FIG. 8, in some embodiments, the non-contact sensor 700 comprises an infrared sensor 701 and a weighing sensor 705. The infrared sensor 701 is disposed at the periphery of the entrance 201, and the detection beam of the infrared sensor 701 traverses the entrance 201; the weighing sensor 705 is disposed at the bottom of the housing 100, for detecting the weight change of the litter compartment 200.

Wherein, the weighing sensor 705 can be disposed above the support foot of the mounting plane of the hollow disc-shaped structure of the base of the housing 100, for detecting the total weight change of the litter, feces and pet inside the litter compartment 200.

Referring to FIG. 8, the non-contact sensor 700 further comprises a presence sensor 703, disposed above the entrance 201 of the litter compartment 200.

In some embodiments, the controller 500 is further configured to: when the infrared sensor 701 detects that a pet enters and the weighing sensor 705 detects an increase in weight, confirm that the pet has entered the litter compartment 200, and prohibit the drive mechanism 300 from starting; when the infrared sensor 701 detects that the pet leaves and the weighing sensor 705 detects a decrease in weight, confirm that the pet has left the litter compartment 200, and enter a state to start a cleaning cycle. Specifically, when a pet steps onto the stepping platform of the housing 100 and moves toward the interior of the litter compartment 200, the detection beam of the infrared sensor 701 is blocked, and the controller 500 receives a first trigger signal and enters a to-be-confirmed state; when the pet completely enters the interior of the litter compartment 200, the weighing sensor 705 detects that the weight increase exceeds a preset minimum pet weight threshold, and at this time the controller 500 formally confirms that the pet is present and immediately locks the power supply of the drive mechanism 300 to prevent the cleaning cycle from accidentally starting.

When the pet finishes relieving itself and leaves the litter compartment 200, the detection beam of the infrared sensor 701 is restored to unblocked, and the controller 500 receives a departure signal; when the weighing sensor 705 detects that the weight is reduced to around the baseline value before the pet entered, the controller 500 confirms that the pet has completely left, and enters the preset safety confirmation delay stage.

In some embodiments, the sifter 202 is fixedly disposed inside the litter compartment 200, and the sifter 202 is used for separating the litter from the feces during the rotation of the litter compartment 200. The sifter 202 is an arc-shaped grid structure, vertically disposed along the inner wall of the litter compartment 200.

Continuing to refer to FIG. 5, in some embodiments, at least two rollers 900 are disposed inside the housing 100. The litter compartment 200 is supported on the rollers 900, and the rollers 900 are in rolling contact with the outer surface of the litter compartment 200. The number of the rollers 900 can be four, symmetrically distributed in pairs on the upper hollow disc-shaped plane of the base of the housing 100, respectively located on the left and right sides of the litter compartment 200, forming a four-point positioning support structure to ensure the stability of the litter compartment 200 during rotation.

An annular guide rail is integrally formed on the outer surface of the litter compartment 200 corresponding to the positions of the rollers 900. The outer circumferential surface of the rollers 900 tightly fits with the surface of the annular guide rail, forming a positioning support and rolling guide structure.

It can be understood that the litter box in this embodiment also includes many other components. However, to highlight the innovative aspects of the present invention, the specific structures, arrangement methods and working principles of some other specific components and some conventional components will not be described in detail, but this does not affect the implementability of the present invention.

In some embodiments, an embodiment of the present invention further provides a pet presence detection system for a litter box. This system can be used as an independent modular safety detection unit, integrated into various rotary smart litter boxes, for detecting the presence state of a pet in real time and outputting a safety control signal.

The pet presence detection system at least comprises at least one touch sensor 400 and a controller 500. The touch sensor 400 is configured to be disposed at a position corresponding to the touch sensing area, and detect the presence of a pet through physical contact and output a trigger signal; the physical contact comprises at least one of: direct contact between the pet and the touch sensing area of the litter compartment, and a spacing between the pet and the touch sensing area on the order of millimeters or less.

The controller 500 is electrically connected to the touch sensor 400, and is also configured to be electrically connected to the drive mechanism 300 of the litter box. The controller 500 can employ a microcontroller with a 32-bit ARM (Advanced RISC Machine) architecture as the main control chip, configured to receive the trigger signal output by the touch sensor 400, and control the drive mechanism 300 to stop operation according to the trigger signal.

The pet presence detection system provided by the embodiment of the present invention adopts a contact-type detection principle, is not interfered by factors such as ambient light, dust and hair, has high detection reliability, and can be integrated into existing smart litter boxes as an independent safety protection unit, significantly improving the use safety of the device.

Referring to FIG. 10, in some embodiments, the present invention provides a control method for a litter box. The method is executed by the controller 500 of the litter box, for realizing safety control during the operation of the litter box. The method comprises:

S310: detecting, by at least one touch sensor, whether physical contact occurs between a pet and a touch sensing area of the litter box, the touch sensing area being disposed corresponding to a position where the pet enters or leaves a litter compartment of the litter box, the physical contact comprising at least one of: direct contact between the pet and the touch sensing area of the litter compartment, and a spacing between the pet and the touch sensing area on the order of millimeters or less;

S320: when a physical contact signal is detected, controlling the litter compartment to stop rotating or prohibiting the litter compartment from starting.

It should be understood that the various embodiments described in this specification are not independent of each other, and their technical features can be arbitrarily combined under the premise of no conflict. For structural details, component configurations, material selections, electrical connection relationships and operation modes not described in detail in the above pet presence detection system embodiment and the litter box control method embodiment, reference can be made to the corresponding descriptions of the litter box device embodiment having a contact-type safety detection function in this specification. After reading the full text of this specification, those of ordinary skill in the art can clearly understand the corresponding relationships and technical associations between the various embodiments, and can implement the present invention without additional creative labor.

It should also be noted that, in this text, relational terms such as first and second, etc., are only used to distinguish one entity or operation from another entity or operation, and do not necessarily require or imply any such actual relationship or order between these entities or operations. Moreover, the terms “comprise,” “include” or any other variants thereof are intended to cover a non-exclusive inclusion, such that a process, method, article or device comprising a series of elements not only includes those elements, but also includes other elements not explicitly listed, or also includes elements inherent to such process, method, article or device.

Although the embodiments of the present invention have been shown and described, it can be understood by those of ordinary skill in the art that various changes, modifications, substitutions and variations can be made to these embodiments without departing from the principle and spirit of the present invention, and the scope of the present invention is defined by the appended claims and their equivalent technical features.

What is claimed is:

1. A litter box, comprising:
a housing defining an interior chamber, the interior chamber having an opening;
a litter compartment rotatably mounted in the interior chamber, an entrance of the litter compartment corresponding to the opening, the litter compartment being configured to be driven to rotate at least to separate feces from litter;
wherein at least a portion of the housing or the litter compartment is configured as a touch sensing area for a pet entering or leaving the litter compartment;
a drive mechanism in driving connection with the litter compartment, for driving the litter compartment to rotate;
at least one touch sensor disposed at a position corresponding to the touch sensing area, the touch sensor configured to detect physical contact by a pet and output a trigger signal; the physical contact comprising at least one of: direct contact between the pet and the touch sensing area, and a spacing between the pet and the touch sensing area on the order of millimeters or less; and
a controller electrically connected to the drive mechanism and the touch sensor respectively, the controller being at least configured to: receive the trigger signal output by the touch sensor, and control the drive mechanism to stop operation according to the trigger signal.

2. The litter box of claim 1, wherein the touch sensor comprises a touch sensing electrode, the touch sensing electrode is disposed on an inner surface of the housing at a position corresponding to the touch sensing area, for sending, to the controller, a signal indicative of contact between the pet and the housing.

3. The litter box of claim 1, wherein the touch sensing area comprises at least one of: a surface of the opening, a surface of the entrance, an inner wall surface of the litter compartment, a side wall of the interior chamber of the housing, and a surface of a connection between the opening and the entrance.

4. The litter box of claim 2, wherein the touch sensing electrode is adhered to a surface of the housing by adhesive backing, or is snap-fitted and secured in a pre-formed groove on the inner wall of the housing.

5. The litter box of claim 2, wherein an outer surface of the touch sensor is covered with a waterproof and dustproof protective layer.

6. The litter box of claim 1, wherein the touch sensor comprises a plurality of touch sensing electrodes, and the plurality of touch sensing electrodes are symmetrically disposed on two opposite side walls of the opening, or the entrance, or the connection between the opening and the entrance.

7. The litter box of claim 1, wherein the touch sensor comprises a plurality of touch sensing electrodes, and the plurality of touch sensing electrodes are disposed on a bottom surface and two opposite side walls of the opening, or the entrance, or the connection between the opening and the entrance, thereby forming a closed detection area surrounding the opening, or the entrance, or the connection between the opening and the entrance.

8. The litter box of claim 1, wherein the touch sensor comprises a touch sensing electrode, and the touch sensing electrode is disposed on an inner wall surface of the litter compartment.

9. The litter box of claim 1, further comprising at least one non-contact sensor, the non-contact sensor being one or more of an infrared sensor, a laser sensor, a microwave sensor, a weighing sensor or a Hall sensor, the non-contact sensor being electrically connected to the controller and configured to detect a presence state of a pet.

10. The litter box of claim 9, wherein the controller is configured to:
in a normal working mode, control the drive mechanism to operate based on a detection signal of the non-contact sensor; wherein, during a cleaning cycle, the controller is configured to continuously monitor the touch sensor and control the drive mechanism to stop operation upon receiving the trigger signal.

11. The litter box of claim 9, wherein the controller is further configured to:
when the non-contact sensor detects that the pet has left the litter compartment and the touch sensor does not output the trigger signal within a preset safety confirmation delay, control the drive mechanism to start a cleaning cycle operation.

12. The litter box of claim 10, wherein the controller is further configured to:
when a duration of the trigger signal of the touch sensor exceeds a preset abnormal alarm duration, control to issue an audible and visual alarm.

13. The litter box of claim 11, wherein the controller is further configured to: during the safety confirmation delay, if the touch sensor or the non-contact sensor detects the presence of a pet again, reset a delay timer;
and, after the trigger signal of the touch sensor is released, resume the normal working mode.

14. The litter box of claim 9, wherein the non-contact sensor comprises an infrared sensor and a weighing sensor, the infrared sensor is disposed at a periphery of the entrance or at two ends of a rotation shaft of the litter compartment, a detection beam of the infrared sensor traversing the entrance or an interior space of the litter compartment; the weighing sensor is disposed at a bottom of the housing, for detecting a weight change of the litter compartment.

15. The litter box of claim 14, wherein the controller is further configured to:
when the infrared sensor detects that a pet enters and the weighing sensor detects an increase in weight, confirm that the pet has entered the litter compartment and prohibit the drive mechanism from starting;
when the infrared sensor detects that the pet leaves and the weighing sensor detects a decrease in weight, confirm that the pet has left the litter compartment and enter a state to start a cleaning cycle.

16. The litter box of claim 1, wherein a sifter is fixedly disposed inside the litter compartment, the sifter being used for separating the litter from the feces during rotation of the litter compartment.

17. The litter box of claim 1, wherein at least two rollers are disposed inside the housing;
the litter compartment is supported on the rollers, and the rollers are in rolling contact with an outer surface of the litter compartment.

18. The litter box of claim 1, wherein the touch sensor is at least one selected from a capacitive touch sensor, a resistive touch sensor and a piezoelectric touch sensor.

19. A pet presence detection system for a litter box, comprising:
at least one touch sensor configured to be disposed at a position corresponding to a touch sensing area of the litter box, for detecting presence of a pet through physical contact and outputting a trigger signal; the physical contact comprising at least one of: direct contact between the pet and the touch sensing area of a litter compartment, and a spacing between the pet and the touch sensing area on the order of millimeters or less;
a controller electrically connected to the touch sensor, the controller configured to:
receive the trigger signal output by the touch sensor, and control a drive mechanism of the litter box to stop operation according to the trigger signal.

20. A control method for a litter box, comprising:
detecting, by at least one touch sensor, whether physical contact occurs between a pet and a touch sensing area of the litter box, the touch sensing area being disposed corresponding to a position where the pet enters or leaves a litter compartment of the litter box, the physical contact comprising at least one of: direct contact between the pet and the touch sensing area of the litter compartment, and a spacing between the pet and the touch sensing area on the order of millimeters or less;
when a physical contact signal is detected, controlling the litter compartment to stop rotating or prohibiting the litter compartment from starting.
